(19) United States
(12) Patent Application Publication
(10) Pub. No.: US 2005/0107571 A1
(43) Pub. Date: May 19, 2005

(54) Method for producing aromatic polyether

(75) Inventors: Shohsuke Kondoh, Niihama-shi (JP); Masaru Oota, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/989,611

(22) Filed: Nov. 17, 2004

(30) Foreign Application Priority Data
Nov. 19, 2003 (JP) 2003-388924

(51) Int. Cl. C08G 75/00

(52) U.S. Cl. 528/174

(57) ABSTRACT

Disclosed herein is a method for producing aromatic polyether which has a less coloring and high transparency and can be used for various purposes without limitation. The method comprises polymerizing (1) a substantially equimolar mixture of a dihydric phenol compound and a dihalogenobenzenoid compound and/or (2) a halophenol, in an organic solvent having high polarity, in the presence of at least one compound selected from the group consisting of alkali metal carbonates, alkali metal bicarbonates, and alkali metal hydroxides in an amount providing at least equivalent atoms of alkali metal to the phenolic hydroxyl groups, and in the presence of oxalic acid or an alkali metal salt thereof in an amount of 0.01 to 0.5% in terms of oxalic acid with respect to the weight of aromatic polyether to be obtained.

### BACKGROUND OF THE INVENTION

1. Field of the Invention

The present invention relates to a method for producing aromatic polyether with less coloring.

2. Description of the Related Art

Various methods for producing aromatic polyether have been suggested. As a representative example, there is known a method in which an alkali metal salt of a dihydric phenol compound, obtained by the reaction between a dihydric phenol compound and an alkali metal hydroxide, is reacted with a dihalogenobenzenoid compound in sulfoxide or sulfone as a solvent having a high boiling point (e.g., dimethyl sulfoxide and sulfolane) (see JP No. 42-7799 A, for example).

Further, as a method for producing aromatic polyether with less coloring, there is known a method in which (1) a dihydric phenol compound and a dihalogenobenzenoid compound or (2) a halophenol is reacted with an alkali metal carbonate or an alkali metal bicarbonate in an inert sulfone solvent system in the presence of a trivalent organophosphorus compound (see JP No. 03-23570 A, for example), or in the presence of hypophosphorous acid (see JP No. 09-316189 A, for example).

The method for producing aromatic polyether by using a phosphorus compound, especially by using hypophosphorous acid, is excellent for preventing coloring the obtained aromatic polyether. However, it is difficult to completely remove a by-produced phosphorus compound in a purifying process of polyether which is carried out subsequently. Therefore, such a method cannot be employed as a method for preventing coloring the obtained aromatic polyether used for applications where the presence of a phosphorus compound should be avoided. For this reason, a method for producing the aromatic polyether with less coloring without using a phosphorus compound.

### SUMMARY OF THE INVENTION

It is therefore an object of the present invention to provide a method for producing aromatic polyether which has high transparency and less coloring and can be used for various purposes without limitation.

In order to achieve the above object, the present inventors have intensively investigated a method for producing aromatic polyether. As a result, it is found that the use of oxalic acid makes it possible to obtain aromatic polyether with less coloring and high transparency, and that the oxalic acid is almost completely decomposed in the polymerization process so that the finally obtained aromatic polyether contains substantially no oxalic acid, and the present invention has been completed.

That is, the present invention provides a method for producing aromatic polyether, the method comprising polymerizing (1) a substantially equimolar mixture of a dihydric phenol compound and a dihalogenobenzenoid compound and/or (2) a halophenol, in which the halogen atoms of the dihalogenobenzenoid compound or the halophenol have been activated by —SO₂— or —CO— group bonded at the ortho- or para-position to the halogen atom, in an organic solvent having high polarity, in the presence of at least one compound selected from the group consisting of alkali metal carbonates, alkali metal bicarbonates, and alkali metal hydroxides in an amount providing at least equivalent atoms of alkali metal to the existing phenolic hydroxyl groups, and in the presence of oxalic acid or an alkali metal salt thereof in an amount of 0.01 to 0.5% in terms of oxalic acid with respect to the weight of aromatic polyether to be obtained.

According to the present invention, it is possible to obtain aromatic polyether having a low yellow coloration and high transparency, that is, it is possible to obtain a polymer with less color. Further, since the added oxalic acid does not remain in the finally obtained aromatic polyether, the aromatic polyether obtained by the method of the present invention can be used for various purposes without limitation.

Furthermore, since the aromatic polyether obtained by the method of the present invention has excellent heat resistance, mechanical properties, and chemical resistance, the polymer is suitably used for manufacturing parts to be exposed to high temperatures, such au electric and electronic parts, electric contact parts, heat-resistant coating materials, hot water-resistant appliances, sliding parts, coating materials, heat-resistant paint, cooking ware, medical appliances, heat-resistant films, and the like.

### PREFERABLE EMBODIMENT OF THE INVENTION

An example of dihydric phenol compound to be used as monomer in the present invention includes bisphenols represented by the general formula (1); 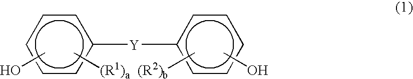
wherein Y represents an alkylene group or an alkylidene group having 1 to 5 carbon atoms, a cycloalkylene group, having 5 to 15 carbon atoms a cycloalkylidene group having 5 to 15 carbon atoms, one of —O—, —CO—, —SO₂—, —S—, or a direct bond between two benzene rings, R¹ and R² are selected from —CH₃, —CH(CH₃)₂, —OCH₃, and —OC₂H₅, and R¹ and R² may be the same or different from each other, and a and b are independently integers of 0 to 4.

Preferred examples of such dihydric phenols compound include 4,4′-dihydroxydiphenyl sulfone, 4,4′-dihydroxydiphenyl, 4,4′-dihydroxydiphenyl sulfide, 4,4′-dihydroxybenzophenone, 2,2-bis-(4-hydroxyphenyl)propane, and bis-(4-hydroxyphenyl)methane. Each of these compounds may be substituted with a methyl group at the ortho-position on the benzene ring.

Among the above compounds, compounds represented by the general formula (4) are more preferred: 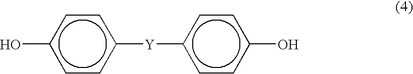
wherein Y represents the same as described above.

An example of dihalogenobenzenoid compound to be used as an other monomer in the present invention include compounds represented by the general formula (2): 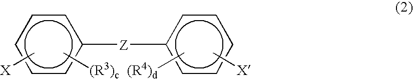
wherein X and X′ are halogen atoms and are at the ortho- or para-position with respect to Z, and may be the same or different from each other, Z represents —SO₂— or —CO—, R³ and R⁴ are selected from —CH₃, —CH(CH₃)₂, —OCH₃, and —OC₂H₅, and R³ and R⁴ may be the same or different from each other, and c and d are independently integers of 0 to 4.

Preferred examples of such dihalogenobenzenoid compounds include 4,4′-dichlorodiphenyl sulfone, 4,4-difluorodiphenyl sulfone, 4,4′-dichlorobenzophenone, and 4,4′-difluorobenzophenone. Each of these compounds may be substituted with a methyl group at the ortho-position on the benzene ring.

Among the above compounds, compounds represented by the general formula (5) are more preferred: 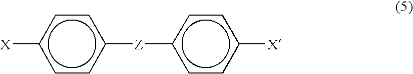
wherein X, X′, and Z each represent the same as described above.

The amount of the dihalogenobenzenoid compound to be used in the present invention is substantially equimolar to the dihydric phenol compound. The dihalogenobenzenoid compound is preferably used in an amount of about 90 to 110 mol % to the dihydric phenol compound. In order to obtain a polymer having a higher molecular weight, the dihalogenobenzenoid compound is more preferably used in an amount of about 98 to 105 mol %.

An example of a halophenol to be used as another monomer in the present invention include compounds represented by the general formula (3): 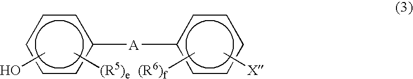
wherein X″ is a halogen atom and is at the ortho- or para-position to A. A represents —SO₂— or —CO—, R⁵ and R⁶ are selected from —CH₃, —CH(CH₃)₂, —OCH₃, and —OC₂H₅, and R⁵ and R⁶ may be the same or different from each other, and e and f are independently integers of 0 to 4.

Preferred examples of such halophenols include
4-(4-chlorophenylsulfonyl)phenol,
4-(4-fluorophenylsulfonyl)phenol, 4-(4-chlorobenzoyl)phenol,
4-hydroxy-4′-(4-chlorophenylsulfonyl)biphenyl, and
4-(4-hydroxyphenylsulfonyl)-4′-(4-chlorophenylsulfonyl)biphenyl.

Examples of an organic solvent having high polarity include dimethyl sulfoxide, N-methyl-2-pyrrolidone, sulfolane(1,1-dioxothiolan), 1,3-dimethyl-2-imidazolidinone, 1,3-diethyl-2-imidazolidinone, diethyl sulfone, diisopropyl sulfone, and diphenyl sulfone.

Preferred examples of alkali metal carbonates, alkali metal bicarbonates, and alkali metal hydroxides include sodium carbonate, potassium carbonate, sodium bicarbonate, potassium bicarbonate, sodium hydroxide, and potassium hydroxide.

At least one compound selected from the group consisting of alkalimetal carbonates, alkalimetal bicarbonates, and alkali metal hydroxides is used in such an amount as to provide at least one alkali metal atom per one phenolic group of the dihydric phenol compound and/or halophenol, preferably in an amount of about 0.5 to 25 molt excess over the amount of phenolic group of the dihydric phenol compound and/or halophenol.

If the compound is used in a larger amount than the above upper value, a obtained polymer may be subject to cleavage or decomposition. On the other hand, if the compound is used in too small amount, the molecular weight of a obtained polymer may become low.

Preferred examples of an alkali metal salt of oxalic acid to be used in the present invention include sodium oxalate and potassium oxalate. The amount of oxalic acid or an alkali metal salt thereof to be added is in the range of about 0.01 to 0.5%, preferably in the range of about 0.03 to 0.3% in terms of oxalic acid with respect to the weight of aromatic polyether to be obtained. In the present invention, the weight of aromatic polyester to be obtained is considered to be the same as the total weight of the monomers such as dihydric phenol compound, dihalogenobenzenoid compound and halophenol.

If the amount of oxalic acid or an alkali metal salt thereof to be added is less than about 0.01%, addition of oxalic acid or an alkali metal salt thereof does not necessarily show sufficient effect on suppressing coloring. On the other hand, even if the amount of oxalic acid or an alkali metal salt thereof to be added is more than about 0.5%, the addition does not usually show larger effect on suppressing coloring any more.

Since the oxalic acid on its residue is almost completely decomposed when heated during the polymerization reaction, it does not remain in the finally obtained aromatic polyether.

The polymerization reaction temperature varies depending on a monomer to be used or the properties of a solvent to be used, and usually is in the range of about 80 to 400° C., preferably in the range of about 100 to 350° C. If the reaction temperature is too law, a polymerization reaction may not sufficiently proceed, and a polymer having a desired molecular weight may not be obtained. On the other hand, if the reaction temperature is too high, a side reaction may occur and the resulting polymer may be highly colored.

The polymerization reaction may be carried out at a constant temperature, or may be carried out while changing a temperature little by little or stepwise.

The time required for the polymerization reaction varies widely depending on the kinds of monomers to be used for the reaction, the type of polymerization reaction, or the reaction temperature, but is usually in the range of about 1 to 24 hours, preferably in the range of about 2 to 12 hours.

In the polymerization reaction, in a case where an alkali metal carbonate or an alkali metal bicarbonate is used, the carbonate or the bicarbonate is decomposed by the reaction with the phenol to generate carbon dioxide and water, and in a case where an alkali metal hydroxide is used, the alkali metal hydroxide is reacted with the phenol to generate water. The polymerization reaction is preferably carried out under a gentle current of inert gas in order to prevent the phenol or a generated polymer from being colored due to oxidation and in order to remove the generated water at a higher temperature.

In the present invention, reactants are usually cooled to terminate the polymerization reaction, but if necessary a halogenated compound such as an aliphatic halide or an aromatic halide may also be added for carrying out a reaction to stabilize a phenoxide terminal which may exist at the terminal of the obtained polymer.

Specific examples of such a halogenated compound include methyl chloride, ethyl chloride, methyl bromide,
4-chlorodiphenyl sulfone, 4-fluorodiphenyl sulfone,
4-chlorobenzophenone, 4-fluorobenzophenone,
4,4′-difluorodiphenylsulfone, 4,4′-dichlorodiphenylsulfone,
4,4′-difluorobenzophenone, and p-chloronitrobenzene.

When the polymer is separated and purified after the completion of the polymerization reaction, a well-known method can be employed.

Specifically, in a case where polymerization has been carried out using a solvent which is in solid form at room temperature, the produced polymer can be obtained by pulverizing a mixture of the polymer, a salt, and the solvent and then extracting the salt and the solvent by the use of a poor solvent for the polymer to remove them.

Examples of the poor solvent for the polymer to be generally used include methanol, acetone, water, isopropanol, methyl ethyl ketone, and ethanol. These poor solvents for the polymer can be used singly or in combination of two or more of them.

### EXAMPLES

Herein below, the present invention will be described in detail with reference to Examples and Comparative Examples, but the present invention is not limited to these Examples.

Reduced viscosities (RV) in Examples and Comparative Examples were determined by the following formula:
RV=(1/C)×[(t−t₀)/t₀]
wherein t represents the efflux time (sec.) of a polymer solution, t₀ represents the efflux time (sec.) of a pure solvent, and C represents the concentration of the polymer solution (expressed in terms of grams per 100 mL of solvent).

Viscosity was measured using an Ostwald viscometer at 25° C. The polymer solution for use in measuring viscosity was prepared by dissolving a polymer in N,N-dimethylformamide so that the concentration thereof became 1.0 g/100 mL.

Light transmittances at a wavelength of 400 nm and 600 nm were measured for a solution prepared by dissolving a polymer in N,N-dimethylformamide so that the concentration thereof became 6.0 g/100 mL, by the use of a spectrophotometer U-3410 (manufactured by Hitachi, Ltd.) and a glass cell having a 10 cm of optical path. Yellow coloration was mainly evaluated based on the light transmittance at 400 nm.

### Example 1

A 0.5 L flask made of SUS316L and equipped with a stirrer, a nitrogen gas inlet tube, a thermometer, and a condenser having a receiver in the tip end thereof was prepared. In the flask, 100.10 g of 4,4′-dihydroxydiphenyl sulfone, 119.90 g of 4,4′-dichlorodiphenyl sulfone, and 196.00 g of diphenyl sulfone were placed, and they were heated to 180° C. with nitrogen gas being circulated in the system to melt monomers.

After adding 0.10 g (0.05% with respect to a polymer to be generated) of oxalic acid, 57.50 g of anhydrous potassium carbonate was added. Thereafter, they were gradually heated to 290° C., and were then reacted for 2 hours at 290° C.

After the reaction was completed, the obtained reaction mixture was cooled to room temperature to be solidified. The reaction mixture was pulverized, repeatedly washed with hot water and a mixed solvent of acetone and methanol several times, and dried by heating at 150° C., to obtain a powdery aromatic polyether (hereinafter, simply referred to as a “polymer”) having a reduced viscosity of 0.35 dl/g. The light transmittances at 400 nm and 600 nm of this polymer were 41.5% and 92.3%, respectively.

### Example 2

A powdery polymer having a reduced viscosity of 0.34 dl/g was obtained in the same manner as in Example 1 except that the amount of oxalic acid was changed to 0.20 g (0.10% with respect to a polymer to be generated).

The light transmittances at 400 nm and 600 nm of this polymer were 42.8% and 91.7%, respectively.

### Comparative Example 1

A powdery polymer having a reduced viscosity of 0.35 dl/g was obtained in the same manner as in Example 1 except that oxalic acid was not added.

The light transmittances at 400 nm and 600 nm of this polymer were 38.4% and 90.5%, respectively.

Reference Example

A powdery polymer having a reduced viscosity of 0.36 dl/g was obtained in the same manner as in Example 1 except that 0.06 g (0.03% with respect to a polymer to be generated) of hypophosphorous acid was added instead of oxalic acid.

The light transmittances at 400 m and 600 nm of this polymer were 42.5% and 93.2%, respectively.

TABLE 1

| | Amount of | Amount of | Reduced | Light | |
|---|---|---|---|---|---|
| | oxalic | hypophos- | viscosity | transmittance | |
| | acid | phorous | (RV) | 400 nm | 600 nm |
| | added (%) | acid added (%) | (dl/g) | (%) | (%) |
| Example 1 | 0.05 | none | 0.35 | 41.5 | 92.3 |
| Example 2 | 0.10 | none | 0.34 | 42.8 | 91.7 |
| Comparative | none | none | 0.35 | 38.4 | 90.5 |
| Example 1 | | | | | |
| Reference | none | 0.03 | 0.36 | 42.5 | 93.2 |
| Example | | | | | |

As is clear from Table 1, the addition of oxalic acid makes it possible to obtain a higher transmittance polymer than the polymer without addition. The yellow coloration expressed in terms of light transmittance at 400 nm is as low as that of a polymer obtained by using hypophosphorous acid.

1. A method for producing aromatic polyether, the method comprising polymerizing (1) a substantially equimolar mixture of a dihydric phenol compound and a dihalogenobenzenoid compound and/or (2) a halophenol, in which the halogen atoms of the dihalogenobenzenoid compound or the halophenol have been activated by —SO₂— or —CO— group bonded at the ortho- or para-position to the halogen atom, in an organic solvent, in the presence of at least one compound selected from the group consisting of alkalimetalcarbonates, alkalimetalbicarbonates, and alkali metal hydroxides in an amount providing at least equivalent atoms of alkali metal to the phenolic hydroxyl groups, and in the presence of oxalic acid or an alkali metal salt thereof in an amount of 0.01 to 0.5% in terms of oxalic acid with respect to the weight of aromatic polyether to be obtained.

2. The method according to claim 1, wherein the dihydric phenol compound is a compound represented by the general formula (1) 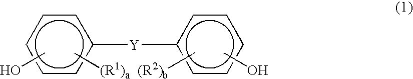
wherein Y represents an alkylene group or an alkylidene group having 1 to 5 carbon atoms, a cycloalkylene group having 5 to 15 carbon atoms, or a cycloalkylidene group having 5 to 15 carbon atoms, one of —O—, —CO—, —SO₂—, —S—, or a direct bond between two benzene rings, R¹ and R² are selected from —CH₃, —CH(CH₃)₂, —OCH₃, and —OC₂H₅, and R¹ and R² may be the same or different from each other, and a and b are independently integers of 0 to 4.

3. The method according to claim 1, wherein the dihalogenobenzenoid compound is a compound represented by the general formula (2): 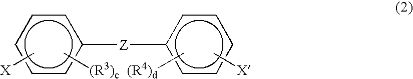
wherein X and X′ are halogen atoms and are at the ortho- or para-position to Z, and may be the same or different from each other, Z represents —SO₂— or —CO—, R³ and R⁴ are selected from —CH₃, —CH(CH₃)₂, —OCH₃, and —OC₂H₅, and R³ and R⁴ may be the same or different from each other, and c and d are independently integers of 0 to 4.

4. The method according to claim 1, wherein the halophenol is a compound represented by the general formula (3): 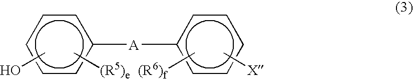
wherein X″ is a halogen atom and is at the ortho- or para-position to A, A represents —SO₂— or —CO—, R⁵ and R⁶ are selected from —CH₃, —CH(CH₃)₂, —OCH₃, and —OC₂H₅, and R⁵ and R⁶ may be the same or different from each other, and e and f are independently integers of 0 to 4.

5. The method according to claim 1, wherein the dihydric phenol compound is 4,4′-dihydroxydiphenyl sulfone, and the dihalogenobenzenoid compound is 4,4′-dichlorodiphenyl sulfone.
